(19) United States
(12) Patent Application Publication
(10) Pub. No.: US 2025/0330341 A1
(43) Pub. Date: Oct. 23, 2025

(54) ENHANCED LOW-POWER STATE OF EMBEDDED DIGITAL PHY CONTROLLER UTILIZING STANDBY OF SYSTEM-ON-CHIP

(71) Applicant: Microchip Technology Incorporated, Chandler, AZ (US)

(72) Inventors: Xin Zhang, Austin, TX (US); Kevin Tran, Austin, TX (US); Thomas Schroeder, Austin, TX (US); Venkatraman Iyer, Austin, TX (US); Eric Ching, Austin, TX (US)

(21) Appl. No.: 19/002,364

(22) Filed: Dec. 26, 2024

Related U.S. Application Data
(60) Provisional application No. 63/637,845, filed on Apr. 23, 2024.

(51) Int. Cl. H04L 12/12

(52) U.S. Cl. CPC H04L 12/12

(57) ABSTRACT

An automotive Ethernet system-on-chip (SoC) implements a power management state that is a lower power standby for an embedded controller of a physical layer (PHY). The SoC combines an always-on power domain (AON) and a switched power domain (SWP). A power manager activates the lower power standby state through a standby signal sent to a power controller in the AON. The standby state enables the power manager of the SoC to switch a system clock from a high-frequency clock to a low frequency clock generated in the AON and turns off a clock dedicated to the PHY.

### CROSS-REFERENCE TO RELATED APPLICATIONS

This application claims the benefit under 35 U.S.C. § 119 (e) of the priority date of U.S. Provisional Patent Application Ser. No. 63/637,845 filed Apr. 23, 2024, for Enhanced Low-Power State of Embedded Digital PHY Controller Utilizing Standby of System-On-Chip, the contents and disclosure of which is incorporated herein in its entirety by this reference.

### BACKGROUND

Automotive Ethernet networks include an increasing number of electronic control units (ECUs) to support various baseband (Base) transmission speeds such as, without limitation, 10Base or 1000Base. With the increasing number of ECUs, reducing power consumption to save energy is a primary requirement. Additionally, reducing the latency, or the delay, of the transition between states of an ECU, such as, without limitation, between a sleep and a wake state, is also an important goal. Open Alliance (OA), a special interest group comprised of automotive technology providers, firms, consultants and companies, has developed standards that define the normal or wake and sleep mode protocols that affect the power consumption of devices within an automotive Ethernet network. For example, the Technical Committee 10 (TC10) of OA define an automotive Ethernet standard that may provide a sleep protocol and a wake or normal protocol or process for many automotive Ethernet networks. The Technical Committee 14 (TC14) of OA coordinates and provides the operational or functional requirements of the ECU elements that may enable the sleep and wake protocols or processes of TC10 in automotive Ethernet networks.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of an apparatus including a standby state, in accordance with one or more examples of the disclosure;

FIG. 2 is a diagram of a system in which the apparatus of FIG. 1 operates in accordance with one or more examples of the disclosure;

FIG. 3 is a flowchart detailing a routine to transition a system to a standby state, in accordance with one or more examples;

FIG. 4 is a diagram of an implementation of standby control logic according to one or more examples;

FIG. 5 is a table detailing system power events and the corresponding operating state of various devices in the system during an event, in accordance with one or more examples;

FIG. 6 is a flowchart detailing a process related to the implementation of a standby state in a system in accordance with one or more examples; and

FIG. 7 is a block diagram of circuitry that, in some examples, may be used to implement various functions, operations, acts, processes, or methods disclosed herein, in accordance with one or more examples.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

An automotive Ethernet system-level chip or system-on-chip (SoC) implements a lower power standby state by switching to a low frequency clock as its MCU cores transition to a programmed idle state. The SoC combines an always-on power domain (AON) and a switched power domain (SWC). A low frequency clock and a power controller of an AON for use in the SWC when the processor cores of the SoC transition to the standby state. During the standby state, the power switch control maintains a power-on state for the SoC. The SoC switches to a low frequency clock generated in the AON in place of a high-frequency clock and shuts off a dedicated clock to a digital controller of a physical layer (PHY). The SoC may transition from the lower power standby state to a normal or wake state by processing a wake command, transitioning the SoC back to the high-frequency clock from the low frequency clock and turning on or activating the PHY clock. Throughout the disclosure, the term “AON”, always-on, is synonymous with always-on power domain. Similarly, the term “SWP”, switched-power, is synonymous with switched power domain. Additionally, in one or more examples, the term “logic”, “circuitry”, and “logic circuitry” may be used synonymously.

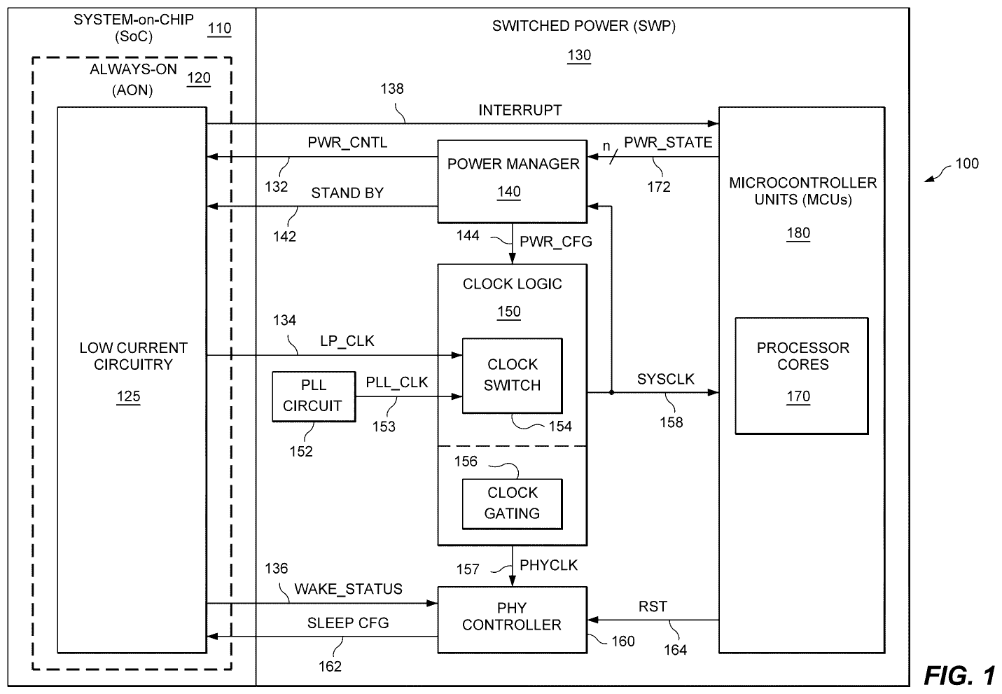

FIG. 1 is a block diagram of an apparatus to implement the lower power standby state, in accordance with one or more examples of the disclosure. Apparatus 100 may be, without limitation, a device that is a media access controller (MAC) or may include the functionality of a MAC or may be an SoC 110 including a number of different integrated functions and devices. In one or more non-limiting examples, an SoC 110 may include an embedded digital PHY controller (PHY) 160. The SoC 110 may combine at least two power domains. In one domain, the power may be connected to a power source that is kHz in an always-on (AON) power domain 120. In another domain, the power may be controlled by an interruptible power source that is able to be switched on and off in a switched power (SWP) domain 130.

The AON 120 is a low-power domain and may include low-current circuitry 125. The SWP 130 may include the embedded digital PHY controller (PHY) 160, one or more processor cores 170 of one or more microcontroller units (MCUs) 180, a power manager 140, and clock logic 150, which may include clock switch 154 logic and clock gating 156 logic.

The processor cores 170 of the SWP 130 may be configured by software to operate in three distinct states including a sleep state, normal or wake state, and a lower power standby state. Throughout this disclosure, the term “normal state” may be used interchangeably with the term “wake state.” The AON 120 may control whether the power to the SWP 130 is turned on or off.

Generally, in a sleep state, the AON 120 may continue to operate using minimal or lower power as will be described in detail later in this disclosure. Minimal or lower power may be considered less than 0.3 milliwatts (mW). However, power to the rest of the SoC 110, including the SWP 130 is off and all processing including clock generation is stopped. In a normal or wake state, the clock logic 150 may operate the clock switch 154 circuitry to generate a system clock SYSCLK 158 as a high-frequency clock PLL_CLK 153 generated by a phase lock loop circuit, PLL Circuit 152, for use by the processor cores 170 and other logic of the SWP 130. The clock gating 156 logic of clock logic 150 operates to generate a clock PHYCLK 157 dedicated for use only by the PHY controller 160.

The lower power standby state may be considered a mode of operation of the SoC 110 between the sleep state and the normal or wake state. The power manager 140 of the SoC 110 may be programmed to recognize a lower power standby state based on the functioning of the processor cores 170. The lower power standby routine is now described in one or more non-limiting examples. It must be noted that the routine as described to enable a lower power standby state from a normal or wake mode is not limited to the process described and may be changed based on the application programming of the MCUs 180 and power manager 140. The lower power standby state may be considered an optional state of the SoC. For example, the SoC may include logic circuitry in the Low-Current Circuitry 125 and the SWP 130 to enable the activation of a lower power standby state. However, the application programming of the MCUs 180 may not be enabled to support the lower power standby state.

In one or more examples, one or more of the processor cores 170 of the MCUs 180 may stop processing and become idle. The idle state of the processor cores 170 may be defined as a state separate from a normal processing or wake state where the processor cores 170 process with full power and a high-frequency clock and also separate from a sleep state where all input power to the SoC 110 is off and clocks are not active. In an idle state one or more of the processor cores 170 may not be processing any applications or functions although the power is on and clocks are active. The processor cores 170 may control the power state of the SoC 110 through software programming of the MCUs 180 that may configure how the transition to a standby state is triggered. The power manager 140 may monitor the state of the cores through PWR_STATE 172. Although the PWR_STATE 172 is shown as a single signal from the MCUs 180 for a simplified representation, those skilled in the art should recognize that the PWR_STATE 172 may include information from multiple signal indicators from the processor cores 170 of multiple MCUs 180.

Power manager 140 may use the PWR_STATE 172 information to determine a lower power standby state and also to control the clock logic 150, depending on the PWR_STATE 172. In one or more examples, clock logic 150 may include logic circuitry such as Clock Switch 154 and clock gating 156.

Power Manager 140 determines the state of the SoC 110 based on the software configuration that defines the PWR_STATE 172 of the processor cores 170. Power manager 140 may assert a state indicator, PWR_CNTL 132 to AON 120 and PWR_CFG 144 to clock logic 150, to initiate operations based on the state of the SoC 110. In one configuration, for example, without limitation, the PWR_STATE 172 may indicate that all processor cores 170 are idle or in a quiescent state. The idle state may cause the power manager 140 to assert a STANDBY 142 signal to the low-current circuitry logic 125 of the AON 120. Power manager 140 may assert the state indicators PWR_CNTL 132 to AON 120 and PWR_CFG 144 to clock logic 150. PWR_CFG 144 may cause the clock switch 154 circuitry to switch the system clock 158 from a high-frequency clock PLL_CLK 153 to a clock of lower frequency LP_CLK 134 generated from the AON 120. The PWR_CFG 144 may also control the clock gating 156 to turn off a gated clock, PHYCLK 157, dedicated to the PHY controller 160 operations. In another configuration, the PWR_STATE 172 that indicates the processor cores 170 are idle may signal a sleep state routine for the SoC 110.

The SoC 110 may transition from a standby state to a wake state based on signals generated from the AON 120. For example, low-current circuitry 125 may receive a wake event that asserts WAKE_STATUS 136 to activate the PHY controller 160 and send an INTERRUPT 138 to the MCUs 180 to wake up the processor cores 170 to operate in a normal state. A wake event is based on programming that signals the processor cores 170 are ready to transition from an idle state to a normal/wake state. The INTERRUPT 138 from the low-current circuitry 125 may be used as part of a wake-up sequence to transition the processor cores 170 from an idle state to a normal state. When the power manager 140 determines, based on PWR_STATE 172, that the processor cores 170 are transitioning from an idle state to a wake or normal state, power manager 140 may operate PWR_CFG 144 to enable clock switch 154 to switch the system clock SYSCLK 158 from the low-power clock LP_CLK 134 back to the high-frequency clock PLL_CLK 153 from PLL Circuit 152. The clock gating 156 logic may also be controlled to turn on the dedicated clock PHYCLK 157 to the PHY controller 160.

By contrast, to transition the SoC 110 from a sleep state where power is off to a wake or normal state, a wake-up sequence may include an external system interrupt (not shown) being sent to the MCUs 180 and processor cores 170 to wake up the cores. The cores may then generate a reset signal RST 164 to wake up the PHY Controller 160. Low current circuitry 125 may also receive configuration commands or parameters from PHY Controller 160, such as without limitation, SLEEP CFG 162 to control a sleep transition sequence of the SoC 110.

It should be recognized that the processes of the SoC may also include circuitry (not shown) to allow signals to cross from the low-current circuitry 125 of the AON 120 to the switched power SWP 130 domain. This circuitry may include, without limitation, one or more of level shifters, isolation cells, power regulators and other similar power translators as would be obvious to one of ordinary skill in the art.

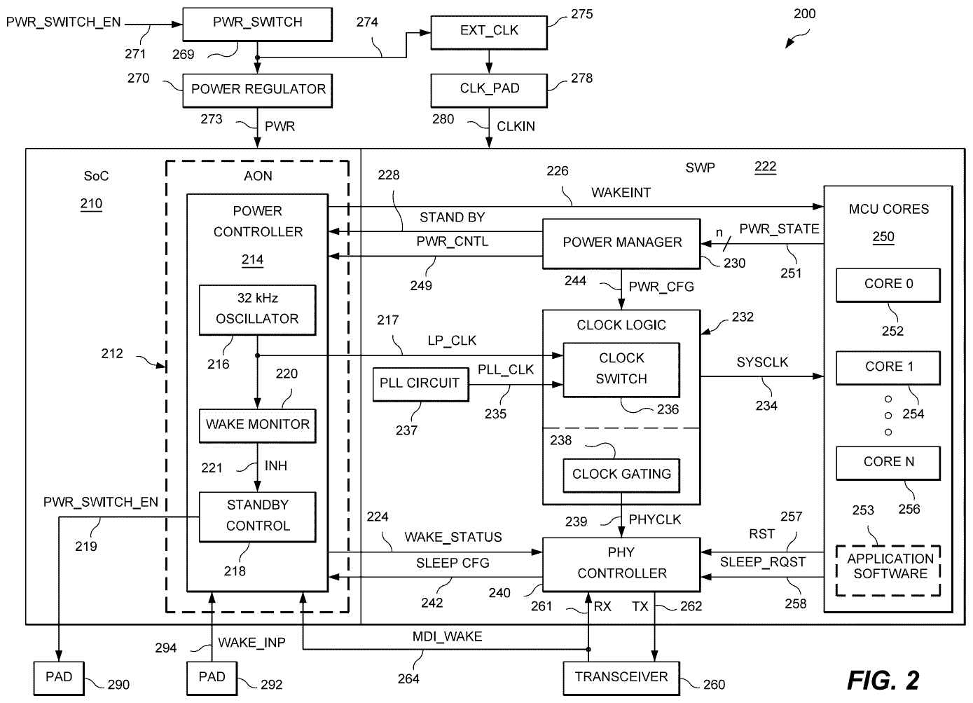

FIG. 2 is a diagram of a system in which the apparatus of FIG. 1 operates in accordance with one or more examples of the disclosure. System 200 may include a SoC 210, that may be configured to operate a lower power standby state as an intermediate power state between a normal state and a sleep state. The lower power standby state may be compatible to operate with existing programming of an Open Alliance Ethernet based standards for a sleep state and normal/wake state. The compatibility of operation means that the low-power standby state may be integrated into the processing for the standards-based sleep state and normal/wake state. For example, without limitation, the SoC may transition from the low-power standby state or a sleep state to a normal or wake state based on application of similar power management controls used to transition the SoC in a standards-based processing routine.

System 200 may include a networked transceiver 260 controlled by or captive to the PHY Controller 240. The SoC 210 may include a number of separate power domains. In examples of this disclosure, SoC 210 combines an AON 212 and a SWP 222. System 200 may include a networked transceiver 260 that is controlled by the embedded PHY controller 240 of the SoC 210. A power regulator 270 may be enabled by a power switch, PWR_SWITCH_EN 269, generated from the AON 212 to turn the power supply PWR 273 to the SoC 210 on or off. Power_switch 269 logic may also control the operation of external clock logic Ext_clk 275 that feeds an SoC clock CLKIN 280 through Clk_Pad 278.

The AON 212 may include power controller 214 circuitry that may operate on a power supply of about 3.3 Volts or less. The power controller 214 may include a 32 kHz oscillator 216, a wake monitor 220, and standby control 218 logic. The 32 kHz oscillator 216 may function as a source of a constant uninterruptable clock for the SoC 210.

The SoC 210 may include a subsystem of a number of MCUs cores 250 from 1 to N, where N is an integer value. In examples of this disclosure, MCU cores 250 includes at least a core 0 252 and a core 1 254. Other MCU cores 250 may be part of the subsystem up to a core N 256. The SoC 210 may include application software 253 that configures the power manager 230 to recognize at least two distinct operating states that include a normal/wake state and a sleep state or mode. In one or more examples of this disclosure, the application software 253 may be programmed to recognize a standby state.

In one or more examples, the wake/normal state and the sleep state may be network states that may already be defined by an automotive ETHERNET® standard, for example, without limitation, the IEEE 802.3cg standard, which includes a 10Base-T1S specification. In the wake/normal state, all the devices, such as, without limitation, electronic control units (ECUs), may be operating and drawing current. In a sleep state, devices may be in a low-current mode where the current draw may be less than 100 microamps (μA). The lower power standby state is an intermediate non-standard ethernet state that may be compatible with the defined standards normal state and standards sleep state. The lower power standby state may be considered an optional state of the SoC 210. The SoC 210 may include logic circuitry to enable its operation, such as, without limitation, standby control 218 of the AON 212. The application software 253 may however exclude programming to enable its use by the SoC 210.

The sleep state is inherently low power since very little to no current is used when the switched power is off and the devices are not processing. The standby state of the SoC 210 is considered lower power even though the current consumption of the SoC may not be less than a current target consumption of 100 μA for the sleep state. Power manager 230 may monitor the power state of the MCU cores 250 through an indicator, such as, without limitation PWR_STATE 251. It should be recognized that PWR_STATE 251 may be an output that includes multiple signals or a single signal to represent one or a number of core processing states. In one example, Core 0 252 and Core 1 254 up to a Core N 256 may each output a signal indicator of its idle state, which may be processed by internal circuitry (not shown) within MCU cores to generate PWR_STATE 251. In another example, the MCU cores 250 may be configured to designate a master core, which receives the processing status of all other cores and outputs a change of PWR_STATE 251 when the processing status of all the cores are the same. More specifically, Core 0 252 may be designated as a master core, which would output signal PWR_STATE 251 that would be determined as idle by the power manager 230, when all the MCU cores 250, Core 0 252, Core 1 254, through Core N 256 are idle.

Continuing with the operation of the power manager 230, it may be configured or programmed through application software 253 to output signals that indicate the idle/sleep state of the MCU cores 250. For example, without limitation, application software 253 may configure MCU cores 250 and power manager 230 to determine a standby state exists if the power state signal, PWR_STATE 251, indicates that all the MCU cores 250 have stopped processing and the MCU cores 250 are transitioning to an idle state or are idle. A STANDBY 228 signal may be output to the power controller 214. A PWR_CFG 244 signal may be output to clock switch 236 of clock logic 232 to switch SYSCLK 234 from a high-frequency clock PLL_CLK 235 generated by PLL circuit 237 to a low frequency clock LP_CLK 217 generated by the 32 kHz oscillator 216 from the AON 212. PWR_CFG 244 may also be used to further reduce power by enabling the Clock Gating 238 logic to shut off the PHYCLK 239 of the PHY controller 240 to 0 Hertz (Hz) while the PHY Controller 240 remains powered on. The application software 253 resident in the MCU cores 250 may send a request SLEEP_RQST 258 to the PHY Controller 240 to place the external transceiver 260 in sleep mode through a signal over TX 262.

As referenced previously, the MCU cores 250 may be configured to enable a sleep state, a wake state and a lower power standby state. A minimum configuration may include the sleep state and the wake state. A power controller 214 in AON 212 may input configuration commands, such as without limitation, sleep configuration parameters SLEEP CFG 242 and status signals related to power states, such as, without limitation PWR_CNTL 249 and STANDBY 228 from the SWP 222. Power Controller 214 may also output status and interrupt commands to components residing in the SWP. Power controller 214 may include a low power 32 kHz oscillator 216, which outputs a clock, LP_CLK 217, of low frequency to control the SoC 210 during a lower power standby state. A Wake monitor 220 may output status and interrupt commands, such as, without limitation, WAKEINT 226 and WAKE_STATUS 224, to devices of the SWP 222 based on commands or signal, such as, without limitation PWR_CNTL 249 to the AON 212 that indicate an operating status of one or more components in the SWP 222. In one or more non-limiting examples, Wake monitor 220 may input status and configuration commands from devices in the SWP 222, which include the signals referenced previously, such as, without limitation, a sleep state configuration command, a wake state interrupt, and a standby state flag. Wake monitor 220 may also output to the SWP 222 a wake state status, WAKE_STATUS 224 and an interrupt, WAKEINT 226 based on the WAKE_STATUS 224. The AON 212 may be isolated from the SWP 222 through the use of isolation logic (not shown) including but not limited to level shifters or similar means known to one of ordinary skill in the art.

The second power domain, SWP 222 may include one or more MCU cores 250. It should be noted that the MCU cores 250 may include, without limitation, microprocessor cores, microcontroller cores, digital-signal-processing cores, as would be obvious to one skilled in the art. SWP 222 may include a power manager 230 and clock logic 232. SWP 222 may also include a physical layer (PHY) controller 240. The PHY controller 240 may control operations of a transceiver 260 that is external to the SoC 210 and coupled or captive to the PHY controller 240.

The SoC 210 may begin a transition from a normal state to a standby state when the power manager 230 determines from indicator PWR_STATE 251 that the MCU cores 250 are in idle or transitioning to an idle state. The power manager 230 may activate a STANDBY 228 signal to the AON 212 when an idle state is detected based on a predetermined configuration by application software 253. Power controller 214 includes a wake monitor 220, which may detect events that transition the SoC 210 to a wake or normal state. Wake monitor 220 may also generate an inhibit signal, INH 221, that may be part of the control for Pwr_switch 269. An asserted inhibit signal, INH 221, may result in the PWR 273 remaining or switching on. A deasserted inhibit signal INH 221 may result in the PWR 273 to the SoC 210 remaining off or switching off only if STANDBY 228 is not active.

In one or more examples of the disclosure, the assertion of a STANDBY 228 signal may be utilized in standby control 218 logic to override the INH 221 signal. As detailed later in the disclosure, the assertion of STANDBY 228 overrides a deasserted INH 221 signal to cause the PWR 273 to the SoC 210 to remain on. Standby control 218 generates a PWR_SWITCH_EN 219 signal, which is output to a pad 290. Pwr_switch 269 logic may input the PWR_SWITCH_EN 271 output from pad 290 to control through a Power regulator 270 whether PWR 273 is enabled or disabled to the SoC 210. The Pwr_switch 269 output 274 may also control power to an external clock source, Ext_clk 275, which drives a clock input CLKIN 280 to the SoC 210 through a Clk_pad 278.

The SoC 210 may be configured to transition from a standby state to a wake state in a manner similar to a transition from a sleep state to a wake state. In one or more examples, a wake event may be sent by a signal from a device external to the SoC 210 and the signal WAKE_INP 294 is input through a pad 292 to power controller 214. In one or more examples, a networked device, such as without limitation, a transceiver 260, may receive a wake event from a network, such as, without limitation, a wakeup tone or request, or other global system signal, and transmit the wake signal over RX 261 line and also send a wake signal MDI_WAKE 264 over an interface to the power controller 214 of AON. The wake event is processed by wake monitor 220 to send a WAKE_STATUS 224 to transition the PHY controller to a normal state. Wake monitor 220 also sends a WAKEINT 226 to transition the MCU Cores 250 from a standby state to a normal or wake state. The STANDBY 228 signal is deasserted, and standby control 218 controls PWR_SWITCH_EN 219 by only the INH 221 signal.

To transition the SoC 210 from a sleep state where power is off to a wake or normal state, a wake-up sequence may include an external system interrupt (not shown) being sent to the MCU Cores 250 to wake up the cores. The cores may then generate a reset signal RST 257 to wake up the PHY Controller 261 which in a sequence wakes up the transceiver through a signal sent over TX 262.

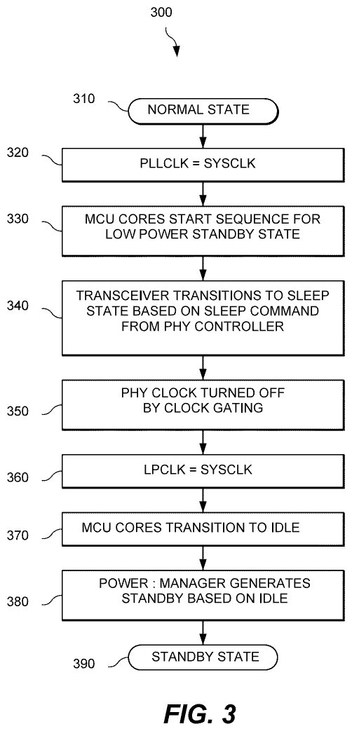

FIG. 3 is a flow diagram detailing a routine to transition a system to a standby state, in accordance with one or more examples. In one or more examples, a process 300 may begin the routine of transitioning to a standby state. It must be noted that the transition routines may vary depending on the programming of the application software that may control the power management. For example, without limitation, application software, such as Application Software 253 of FIG. 2, may be programmed to specify which states of the SoC will be operational and control and/or monitor the routines that determine the transitions between the states.

The routine may start at block 310 with the MCU cores in a normal state. The normal state may be a state where the microprocessor cores and other components of the SoC are operating at full speed or maximum capacity. In the normal mode or state 310, a high-frequency clock, such as PLL_CLK 235 of FIG. 2, controls the operating system for the SoC including the MCU cores. PLLCLK=SYSCLK 320 indicates that the system clock SYSCLK is being driven by the PLLCLK in the normal state of the SoC. In examples of this disclosure, the normal state may also be considered to be the wake or full power state to which microprocessor cores may transition from another state such as a sleep state or a standby state.

At block 330, the power management control may initiate or start a standby state sequence through application software, such as application software 253 of FIG. 2, when all the MCU cores indicate to the power management control that they are in an idle state and no processing is being done. The power management control may command the PHY controller to place its transceiver in a sleep state by sending a sleep request, such as SLEEP_RQST 258 of FIG. 2. At block 340, the transceiver transitions to a sleep state based on the sleep command from the PHY controller. The power management control may next control the clock circuitry so that the PHY clock is turned off through clock gating 350. A clock that is off is completely stopped and does not generate any signals. Its frequency may be considered to be 0 Hz.

The process may then enable the low-power clock, such as LP_CLK 217 of FIG. 2, to drive the system clock, such as SYSCLK 234 of FIG. 2. LPCLK=SYSCLK 360 indicates that the system clock SYSCLK is being driven by the LPCLK in the standby state of the SoC. At block 370, the MCU cores may finalize its transition to IDLE mode, if the transition has not already been completed.

The power manager may be programmed or configured to generate a standby signal when the MCU cores are idle. At block 380, the power manager generates a standby signal based on the idle mode of the MCU cores. At block 390, the SoC in a standby state operates on LPCLK, the low-power clock, until a wake event is detected to transition the SoC to normal mode.

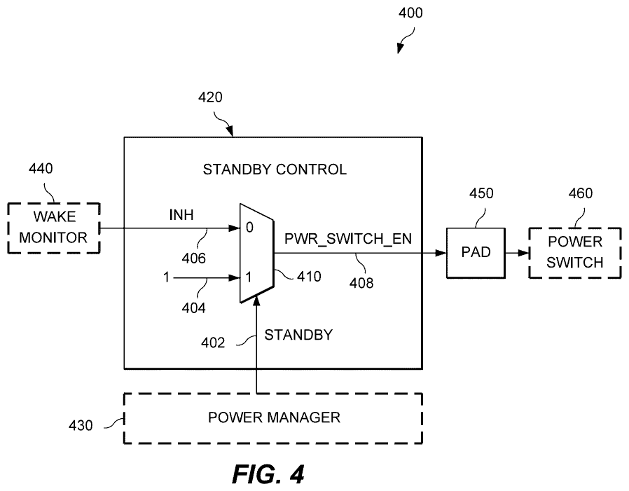

FIG. 4 is a diagram of an implementation of standby control logic according to one or more examples. It should be appreciated that other implementations of standby control logic may be possible as may be obvious to one skilled in the art. In control logic 400, the power manager 430 may be programmed to activate a standby state or mode. In one or more examples, the power manager may be programmed to transition a controller or SoC to a standby state when all controller cores are idle and not processing any applications. A standby signal may be sent from an optional power manager 430 in an SWP to standby control 420 logic in an AON domain. The standby control utilizes a signal output from logic circuitry such as for example, optionally, wake monitor 440, that typically controls whether or not the SoC is in a sleep state or normal state. If a standby state is not operational or standby 402 signal is inactive or 0, then the signal output INH 406 controls whether or not the power to the SoC is on or off. In one non-limiting example, if INH 406 has an integer value of “1,” this value will be output from mux switch 410 to drive PWR_SWITCH_EN 408 through a pad 450 to external logic blocks of the SoC such as, optionally, a power switch 460. The PWR_SWITCH_EN 408 signal may operate to control the power switch 460. The power switch 460 may be programmed to maintain or turn on power when PWR_SWITCH_EN 408 is an active high. Conversely, the power switch 460 may also be programmed to turn off power when PWR_SWITCH_EN 408 is an active low.

If a standby state is programmed as a state for the SoC, the output of mux switch 410 PWR_SWITCH_EN 408 may be driven by signal 404 tied to a logic value of “1” 404. The PWR_SWITCH_EN 408 may control the power switch 460 to maintain or turn on the power.

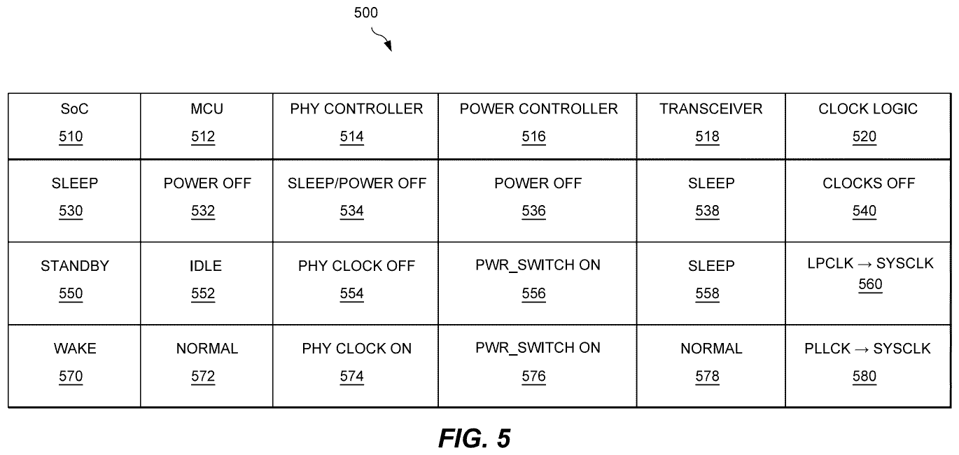

FIG. 5 is a table detailing system power events and the corresponding operating state of various devices in the system during a power event, in accordance with one or more example. Table 500 illustrates the states or configuration of devices associated with the SoC, including, but not limited to, an MCU 512, PHY controller 514, power controller 516, transceiver 518, and clock logic 520. An SoC 510 may define Ethernet modes that include Sleep 530, Standby 550 and Wake 570. The sleep 530 and wake 570 states or modes of an Ethernet network are typically defined by Ethernet standards. In sleep 530, the SoC 510 is not processing and is in a no power on mode. Therefore, table 500 indicates device MCU 512 is in Power Off 532, PHY Controller 514 in Power Off 534, power controller 516 in Power Off 536, external transceiver 518 in Sleep 538, and clock logic 520 is Clocks Off 540 for all clocks. The low-power clock generated by the AON, such as the LP_CLK 217 of FIG. 2, may still be operational since power to the AON is kHz, but devices in the SWP in a power off state cannot utilize the clock.

Returning to table 500, the SoC 510 in Wake 570 mode is operating in a full processing power mode. In Wake 570, the MCU 512 is in Normal 572, the PHY Controller has PHY Clock On 574, the Power Controller 516 has PWR_Switch On 576, the Transceiver in Normal 578 to receive, and send data and Clock Logic 520 has a PLLCK operating as the SYSCLK, PLLCLK→SYSCLK 580.

The SoC 510 in Standby mode is operating in a low-power mode. In Standby 550, the MCU in Idle 552, the PHY Controller has PHY Clock off 554, the Power Controller 516 in PWR_Switch 556, the Transceiver in Sleep 558, and Clock Logic 520 has low-power clock LPCLK operating as the SYSCLK, LPCLK→SYSCLK 560.

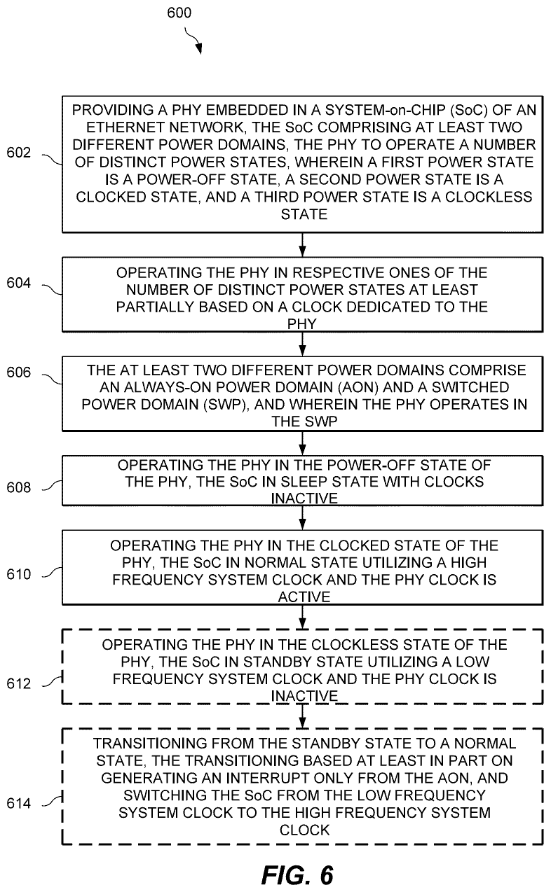

FIG. 6 is a flow diagram detailing a process related to the implementation of a standby state in a system in accordance with one or more examples. Process 600 may begin at block 602 by configuring a system-on-chip (SoC) with at least two power domains to include an embedded PHY controller with three distinct power states. The embedded PHY controller may be part of an Ethernet network. A first state of the SoC is a sleep state that corresponds to a power-off state. A second state of the SoC may be a normal or wake state that corresponds to a clocked state where all the clocks generated in the SoC are operating and active. For example, in the clocked state, a low frequency clock, such as LP_CLK 134 may be active in a first power domain, a high frequency clock, such as PLL_CLK 152 of FIG. 1, may be active in a second power domain, along with a gated clock to the PHY controller, such as, for example, PHY clock 157 of FIG. 1. A third state of the SoC is a standby state that corresponds to a low-power clock state in which a low-frequency clock is the system clock and the PHY controller is in a clockless state. The PHY controller uses a clock dedicated to operating the PHY only. A “clockless state” refers to time periods when the PHY clock is off, for example, without limitation, the PHY clock is inactive or gated off, or not operational, for example, without limitation, a clock source for the PHY clock is disabled or does not generate a clock signal.

At block 604, it may be recognized that the SoC or microcontroller includes an always-on power (AON) domain and a switched power (SWP) domain. A power controller that determines the power state of the SoC is in the AON and the embedded PHY controller is in the SWP. At block 606, the process may include acts of operating the PHY controller in a respective power state based on a clock dedicated to the PHY controller.

At block 608, the process may include acts of operating the PHY controller in the sleep state while operating the PHY controller in the power-off state, wherein the microcontroller is powered-off while the PHY operates in the sleep state.

At block 610, the process may include acts of operating the PHY in a wake state while operating the PHY controller in the clocked state, wherein a clock of the microcontroller is a high-frequency clock while the PHY operates in a wake state.

At block 612, the process may include acts of operating the PHY in a standby state while operating the PHY controller in the clockless state, wherein the clock of the microcontroller is a low frequency clock while the PHY operates in a clockless state.

At block 614, the process may include exiting the standby state of the PHY controller and SoC by an interrupt generated in the AON.

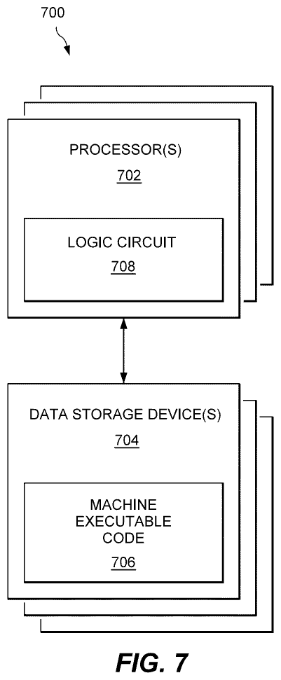

FIG. 7 is a block diagram of a circuitry 700 that, in some examples, may be used to implement various functions, operations, acts, processes, or methods disclosed herein. The circuitry 700 includes one or more processors 702 (sometimes referred to herein as “processors 702”) operably coupled to one or more data storage devices 704 (sometimes referred to herein as “storage 704”). The storage 704 includes machine executable code 706 stored thereon, and the processors 702 include logic circuit 708. The machine executable code 706 includes information describing functional elements that may be implemented by (e.g., performed by) the logic circuit 708. The logic circuit 708 is adapted to implement (e.g., perform) the functional elements described by the machine executable code 706. The circuitry 700, when executing the functional elements described by the machine executable code 706, should be considered as special purpose hardware for carrying out functional elements disclosed herein. In one or more examples, the processors 702 may perform the functional elements described by the machine executable code 706 sequentially, concurrently (e.g., on one or more different hardware platforms), or in one or more parallel process streams.

When implemented by logic circuit 708 of the processors 702, the machine executable code 706 adapts the processors 702 to perform operations of examples disclosed herein. By way of non-limiting example, the machine executable code 706 may adapt the processors 702 to perform some or a totality of operations. Also by way of non-limiting example, the machine executable code 706 may adapt the processors 702 to perform some or a totality of features, functions, or operations disclosed herein.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 702, including, without limitation, a general-purpose processor, is considered a special-purpose computer at least while the general-purpose computer executes functional elements corresponding to the machine executable code 706 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, the one or more processors 702 may include any conventional processor, controller, microcontroller, or state-machine. An FPGA or other PLD of the processors 702 may be configured (e.g., programmed, without limitation) with configuration data to perform functions disclosed herein, or, additionally or alternatively, may be capable of being configured or re-configured (e.g., programmable or re-programmable, without limitation) with configuration data to perform functions disclosed herein. The processors 702 may also be implemented as a combination of computing devices, such as a combination of a DSP and a microprocessor, a plurality of microprocessors, one or more microprocessors in conjunction with a DSP core, or any other such configuration.

In one or more examples, the storage 704 includes volatile data storage (e.g., random-access memory (RAM), static RAM (SRAM), without limitation), non-volatile data storage (e.g., Flash memory, a hard disc drive, a solid state drive, erasable programmable read-only memory (EPROM), without limitation). In some examples, the processors 702 and the storage 704 may be implemented into a single device (e.g., a semiconductor device product, a system on chip (SoC), without limitation). In some examples, the processors 702 and the storage 704 may be implemented into separate devices.

In one or more examples, the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuit 708. Also by way of non-limiting example, the computer-readable instructions may be stored on the storage 704, transferred to a memory device (not shown) for execution, and executed by the processors 702 using at least the logic circuit 708. Processors 702 or logic circuit 708 thereof be coupled to such a memory device or include such a memory device (e.g., a configuration memory cell, without limitation). Accordingly, in some examples, the logic circuit 708 includes electrically configurable logic circuit 708.

In one or more examples, the machine executable code 706 may describe hardware (e.g., circuitry) to be implemented in the logic circuit 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, SYSTEMVERILOG™, or very-large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 708 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine executable code 706 may include an HDL, an RTL, a GL description, a mask level description, other hardware description, or any combination thereof.

In examples where the machine executable code 706 includes a hardware description (at any level of abstraction), a system (not shown, but including the storage 704) implements the hardware description described by the machine executable code 706. By way of non-limiting example, the processors 702 may include a programmable logic device (e.g., an FPGA or a PLC, without limitation) and the logic circuit 708 may be electrically controlled (e.g., via configuration data, without limitation) to implement circuitry corresponding to the hardware description into the logic circuit 708. Also by way of non-limiting example, the logic circuit 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuit 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:
Example 1: An apparatus, comprising: a first power domain; and a second power domain different from the first power domain, the second power domain comprising a controller of a physical layer (PHY) of an Ethernet, wherein the PHY operates in a number of distinct power states at least partially based on a clock dedicated to the PHY, wherein a first operating state of the number of distinct power states is a power-off state, a second operating state of the number of distinct power states is a clocked state, and a third operating state of the number of distinct power states is a clockless state.
Example 2: The apparatus according to Example 1, wherein the power-off state is part of a sleep state, the clocked state is part of a wake state, and the clockless state is part of a standby state.
Example 3: The apparatus according to Examples 1 and 2, wherein the third state of operation of the PHY is optional.
Example 4: The apparatus according to any of Examples 1 to 3, comprising a power controller of the first power domain, the power controller comprising: a low-frequency oscillator to generate a clock of low frequency; and a wake monitor clocked by the low frequency clock to control a current state of the PHY.
Example 5: The apparatus according to any of Examples 1 to 4, wherein in a transition to the power-off state, the wake monitor deasserts a power switch enable signal to transition the second power domain to the power-off state.
Example 6: The apparatus according to any of Examples 1 to 5, wherein in a transition to the clocked state from the clockless state, the wake monitor generates an interrupt signal to switch a system clock from the low frequency clock to a high-frequency clock and activates the PHY clock.
Example 7: The apparatus according to any of Examples 1 to 6, comprising a standby control to, at least partially responsive to a standby signal, generate a power switch enable signal to transition the PHY to a standby state.
Example 8: The apparatus according to any of Examples 1 to 7, wherein the second power domain comprises one or more microcontroller units (MCUs), a power manager and clock logic, wherein the MCUs to operate the power manager to determine an operating state from the number of distinct power states.
Example 9: The apparatus according to any of Examples 1 to 8, wherein in transition to the clockless state, the clock logic disables the PHY clock and switches a system clock from a high-frequency clock to a low frequency clock, based in part on the standby signal, wherein the high-frequency clock runs at a frequency that is greater than the low frequency clock.
Example 10: The apparatus according to any of Examples 1 to 9, wherein the clock circuitry to generate a clock of high frequency and the PHY clock, the PHY clock derived, at least in part, from the clock of high frequency.
Example 11: The apparatus according to any of Examples 1 to 10, wherein the first power domain is an always-on domain and the second power domain is a switched power domain.
Example 12: The apparatus according to any of Examples 1 to 11, comprising a transceiver, wherein the PHY is coupled to the transceiver via a hardware interface.
Example 13: A method, comprising: providing a controller of a physical layer (PHY) of an Ethernet, the PHY embedded in a system-on-chip (SoC) of an Ethernet network, the SoC comprising at least two different power domains, the PHY to operate in a number of distinct power states, wherein a first power state of the number of distinct power states is a power-off state, a second power state of the number of distinct power states is a clocked state, and a third power state of the number of distinct power states is a clockless state; and operating the PHY in respective ones of the number of distinct power states at least partially based on a clock dedicated to the PHY.
Example 14: The method according to Example 13, wherein the at least two different power domains comprise an always-on power domain (AON) and a switched power domain (SWP), and wherein the PHY operates in the SWP.
Example 15: The method according to Examples 13 and 14, wherein in operating the PHY in the power-off state, the SoC in sleep state with clocks inactive.
Example 16: The method according to any of Examples 13 to 15, wherein in operating the PHY in the clocked state, the SoC in normal state utilizing a high-frequency system clock and the PHY clock is active.
Example 17: The method according to any of Examples 13 to 16, wherein in operating the PHY in the clockless state, the SoC in standby state utilizing a low frequency system clock and the PHY clock is inactive.
Example 18: The method according to any of Examples 13 to 17, comprising: transitioning from a standby state to a normal state, the transitioning based at least in part on by generating an interrupt only from the AON; and switching the SoC from a low frequency system clock to a high-frequency system clock.
Example 19: The method according to any of Examples 13 to 18, wherein the PHY clock is generated by clock gating.
Example 20: A system, comprising: a controller of an Ethernet physical layer (PHY) at least partially implemented at a system-on-chip (SoC), wherein the SoC is operable in a number of distinct power states including a sleep state, a standby state, and a normal state, clock logic to switch a clock of the SoC from a first state having a first frequency to a second state having a second frequency, the second frequency lower than the first frequency, wherein the clock logic switches the clock based at least partially on a transition of the SoC to the standby state, and wherein the PHY in a power-off state when the SoC operating in a sleep state, wherein the PHY in a clocked state when the SoC operating in a normal state, wherein the PHY in a clockless state when the SoC operating in a standby state.
Example 21: The system according to Example 20, comprising a transceiver, wherein the standby state of the SoC is compatible with a sleep state of the transceiver of the PHY.
Example 22: The system according to Examples 20 and 21, wherein the PHY to transition from the clockless state to the clocked state at least partially responsive to an event that wakes the SoC.
Example 23: The system according to any of Examples 20 to 22, wherein the PHY to transition from the clockless state to the power-off state at least partially responsive to an event that puts the SoC to sleep.
Example 24: The system according to any of Examples 20 to 23, wherein the PHY to transition from the clockless state to the clocked state based on a reset initiated internal to the SoC.
Example 25: The system according to any of Examples 20 to 24, wherein the transceiver to transition from a sleep state to a normal state at least partially responsive to the transition of the PHY from the clockless state to the clocked state.
Example 26: The system according to any of Examples 20 to 25, wherein the clock logic of the SoC switches to a second state in the standby state.
Example 27: The system according to any of Examples 20 to 26, wherein the SoC comprises at least two different power domains, wherein a first power domain utilizes a clock that is always-on, and wherein a second power domain utilizes a switchable clock.

While the present disclosure has been described herein with respect to certain illustrated examples, those of ordinary skill in the art will recognize and appreciate that many additions, deletions, and modifications to the illustrated and described examples may be made suggested to one skilled in the art without departing from the scope of the invention as hereinafter claimed along with their legal equivalents. In addition, features from one example may be combined with features of another example while still being encompassed within the scope of the invention and such changes, variations, alterations, transformations and modifications are as contemplated by the inventor and within the scope of the appended claims.

What is claimed is:

1. An apparatus, comprising:
a first power domain; and
a second power domain different from the first power domain, the second power domain comprising a controller of a physical layer (PHY) of an Ethernet, wherein the PHY operates in a number of distinct power states at least partially based on a clock dedicated to the PHY, wherein a first operating state of the number of distinct power states is a power-off state, a second operating state of the number of distinct power states is a clocked state, and a third operating state of the number of distinct power states is a clockless state.

2. The apparatus of claim 1, wherein the power-off state is part of a sleep state, the clocked state is part of a wake state, and the clockless state is part of a standby state.

3. The apparatus of claim 1, wherein the third state of operation of the PHY is optional.

4. The apparatus of claim 1, comprising a power controller of the first power domain, the power controller comprising:
a low-frequency oscillator to generate a clock of low frequency; and
a wake monitor clocked by the low frequency clock to control a current state of the PHY.

5. The apparatus of claim 4, wherein in a transition to the power-off state, the wake monitor deasserts a power switch enable signal to transition the second power domain to the power-off state.

6. The apparatus of claim 5, wherein in a transition to the clocked state from the clockless state, the wake monitor generates an interrupt signal to switch a system clock from the low frequency clock to a high-frequency clock and activates the PHY clock.

7. The apparatus of claim 1, comprising a standby control to, at least partially responsive to a standby signal, generate a power switch enable signal to transition the PHY to a standby state.

8. The apparatus of claim 2, wherein the second power domain comprises one or more microcontroller units (MCUs), a power manager and clock logic, wherein the MCUs to operate the power manager to determine an operating state from the number of distinct power states.

9. The apparatus of claim 8, wherein in transition to the clockless state, the clock logic disables the PHY clock and switches a system clock from a high-frequency clock to a low frequency clock, based in part on a standby signal, wherein the high-frequency clock runs at a frequency that is greater than the low frequency clock.

10. The apparatus of claim 8, wherein the clock logic to generate a clock of high frequency and the PHY clock, the PHY clock derived, at least in part, from the clock of high frequency.

11. The apparatus of claim 1, wherein the first power domain is an always-on domain and the second power domain is a switched power domain.

12. The apparatus of claim 1, comprising a transceiver, wherein the PHY is coupled to the transceiver via a hardware interface.

13. A method, comprising:
providing a controller of a physical layer (PHY) of an Ethernet, the PHY embedded in a system-on-chip (SoC) of an Ethernet network, the SoC comprising at least two different power domains, the PHY to operate in a number of distinct power states, wherein a first power state of the number of distinct power states is a power-off state, a second power state of the number of distinct power states is a clocked state, and a third power state of the number of distinct power states is a clockless state; and
operating the PHY in respective ones of the number of distinct power states at least partially based on a clock dedicated to the PHY.

14. The method of claim 13, wherein the at least two different power domains comprise an always-on (AON) and a switched power (SWP), and wherein the PHY operates in the SWP.

15. The method of claim 14, wherein in operating the PHY in the power-off state, the SoC in sleep state with clocks inactive.

16. The method of claim 14, wherein in operating the PHY in the clocked state, the SoC in normal state utilizing a high-frequency system clock and the PHY clock is active.

17. The method of claim 15, wherein in operating the PHY in the clockless state, the SoC in standby state utilizing a low frequency system clock and the PHY clock is inactive.

18. The method of claim 17, comprising:
transitioning from a standby state to a normal state, the transitioning based at least in part on generating an interrupt only from the AON; and
switching the SoC from a low frequency system clock to a high-frequency system clock.

19. The method of claim 13, wherein the PHY clock is generated by clock gating.

20. A system, comprising:
a controller of an Ethernet physical layer (PHY) at least partially implemented at a system-on-chip (SoC), wherein the SoC is operable in a number of distinct power states including a sleep state, a standby state, and a normal state,
clock logic to switch a clock of the SoC from a first state having a first frequency to a second state having a second frequency, the second frequency lower than the first frequency, wherein the clock logic switches the clock based at least partially on a transition of the SoC to the standby state, and
wherein the PHY in a power-off state when the SoC operating in a sleep state,
wherein the PHY in a clocked state when the SoC operating in a normal state, and
wherein the PHY in a clockless state when the SoC operating in a standby state.

21. The system of claim 20, comprising a transceiver, wherein the standby state of the SoC is compatible with a sleep state of the transceiver of the PHY.

22. The system of claim 21, wherein the PHY to transition from the clockless state to the clocked state at least partially responsive to an event that wakes the SoC.

23. The system of claim 22, wherein the PHY to transition from the clockless state to the power-off state at least partially responsive to an event that puts the SoC to sleep.

24. The system of claim 23, wherein the PHY to transition from the clockless state to the clocked state based on a reset initiated internal to the SoC.

25. The system of claim 21, wherein the transceiver to transition from a sleep state to a normal state at least partially responsive to the transition of the PHY from the clockless state to the clocked state.

26. The system of claim 24, wherein the clock logic of the SoC switches to a second state in the standby state.

27. The system of claim 26, wherein the SoC comprises at least two different power domains, wherein a first power domain utilizes a clock that is always-on, and wherein a second power domain utilizes a switchable clock.
